(19) United States
(12) Patent Application Publication
(10) Pub. No.: US 2022/0178434 A1
(43) Pub. Date: Jun. 9, 2022

(54) LOCKING DIFFERENTIAL

(71) Applicant: Dana Italia S.r.l., Arco (IT)

(72) Inventors: Andrea SACCONI, San Giorgio (IT); David DEIMICHEI, Arco (IT)

(73) Assignee: Dana Italia S.r.l., Arco (IT)

(21) Appl. No.: 17/457,447

(22) Filed: Dec. 3, 2021

(30) Foreign Application Priority Data
Dec. 3, 2020 (DE) 20 2020 106 976.4

(51) Int. Cl. F16H 48/32; F16H 48/08; F16H 48/24

(52) U.S. Cl. CPC F16H 48/32; F16H 48/24; F16H 48/08

(57) ABSTRACT

A locking differential may have a side gear, a differential planetary carrier for driving the side gear, a locking member for selectively rotationally locking the side gear to the differential planetary carrier, a piston assembly for actuating the locking member, and an elastic member. To rotationally lock the side gear to the differential planetary carrier the piston assembly is configured to actuate the locking member via the elastic member.

### FIELD

The present document relates to the field of mechanical locking differentials. Specifically, the subject matter of this document relates to a mechanical locking differential for a vehicle.

### BACKGROUND

Locking differentials are commonly known in automotive technology. They allow rotationally locking the side gears and the differential planetary carrier, also termed differential housing, of the differential to avoid wheel spinning in driving situations where one wheel loses ground grip or lifts off the ground.

For example, U.S. Pat. No. 5,273,499 discloses a clutch for locking a differential gear for a vehicle in which a movable half of the clutch is pushed indirectly via a sliding sleeve and intermediate members in an engaging direction. Then the sliding sleeve, with a locking surface, retains the intermediate members firmly in a locking position between a bearing surface of the movable half and an axially stationary retaining surface. Flanks of clutch teeth of an axially stationary half and of the movable half form in the axle direction a deflection angle. The bearing surface and the retaining surface form a wedge angle. The locking surface of the sliding sleeve is inclined in an axial direction forming a small releasing angle. To open the clutch, the sliding sleeve is pulled away. A torque produces through the deflection angle an axial deflection force which then disengages the clutch. The intermediate members are, at the same time, pushed out of their locking position by the wedge angle. A small retaining force and a small releasing force on the sliding sleeve are sufficient to keep engaged and to disengage the clutch even against maximum torque.

However, during operation known locking differentials often cause a high degree of wear of mechanical parts which may significantly deteriorate the operability and shorten the service life of the differential.

Thus, there is demand for a locking differential with a prolonged service life.

### SUMMARY

This problem is solved by a locking differential according to the claims. Special embodiments are described in the dependent claims.

Accordingly, a locking differential is provided, particularly a mechanical locking differential for a vehicle. The locking differential comprises a side gear, a differential planetary carrier, also termed differential housing, for driving the side gear. Typically, the differential planetary carrier and the side gear are rotatable with respect to a rotation axis. The locking differential further comprises a locking member for selectively rotationally locking the side gear to the differential planetary carrier. Moreover, the locking differential comprises a piston assembly for actuating the locking member and an elastic member such as a compression spring or the like. In order to rotationally lock the side gear to the differential planetary carrier the piston assembly is configured to actuate the locking member via the elastic member. Typically, the elastic member is disposed between the piston assembly and the locking member.

Due to the fact that the piston assembly is configured to actuate the locking member via the elastic member, in situations where movement or further movement of the locking member during a locking operation is blocked, a force exerted on the locking member via the piston assembly may be limited. For example, even as movement or further movement of the locking member is blocked, the piston assembly may continue at least part of its stroke such as by at least partially compressing the elastic member. In this way, wear of mechanical components can be reduced and the service life of the locking differential can be prolonged.

The piston assembly, the elastic member and the locking member may be configured such that when a locking movement of the locking member is blocked before the locking member rotationally locks the side gear to the differential planetary carrier, the piston assembly is configured to move relative to the locking member by compressing or by partially compressing the elastic member in between the piston assembly and the locking member.

The locking differential may comprise an axle housing portion and a hydraulic chamber formed in between the axle housing portion and the piston assembly. The hydraulic chamber may be configured to be filled with a liquid in order to move the piston assembly to rotationally lock the side gear to the differential planetary carrier. A hydraulic chamber formed into the axle housing allows a compact design of the hydraulic system without requiring additional space in the locking differential. The hydraulic chamber may be fluidly coupled to a hydraulic reservoir and/or a hydraulic pump. One or more seals may be envisaged to be arranged between the piston assembly and the axle housing portion to prevent leakage of liquid from the hydraulic chamber. The liquid may be a lubricant such as hydraulic oil.

The locking differential may further comprise a pushing member disposed in between at least a portion of the elastic member and at least a portion of the locking member such that in order to rotationally lock the side gear to the differential planetary carrier the piston assembly is configured to actuate the locking member via the elastic member and the pushing member. The use of a pushing member allows an actuation of the locking member via the elastic member and the pushing member in an indirect manner such that the piston assembly is free to finish a full stroke even when the movement of the locking member is blocked. The pushing member may be annular-shaped. The pushing member may comprise a first stepped portion or a first annular groove for receiving the elastic member. Preferably, the pushing member may abut an inner surface of the piston assembly such that a lateral movement of the pushing member relative to a moving direction of the piston assembly is prevented. The pushing member may comprise a second stepped portion or a second annular groove for receiving the locking member. Preferably, the pushing member may abut a surface of the locking member facing to the piston assembly such that a lateral movement of the locking member relative to a moving direction of the piston assembly is prevented. The pushing member may be made of a metal such as steel.

The piston assembly may comprise a first mechanical stop and a second mechanical stop. The elastic member or at least a portion of the elastic member may be disposed in between the first mechanical stop and the second mechanical stop such that the first mechanical stop and the second mechanical stop limit movement of the elastic member relative to the piston assembly. Preferably, the mechanical stops are arranged in close proximity to the longitudinal ends of the piston assembly. In this configuration, the size of the elastic member can be increased such that more potential energy may be stored by the compression of the elastic member such that a higher pressure for displacing the piston assembly may be provided.

At least a portion of the pushing member may be disposed in between the elastic member and the second mechanical stop such that the second mechanical stop limits movement of the pushing member relative to the piston assembly. In particular a first front face of the pushing member may abut the second mechanical stop. A second front face of the pushing member opposite to the first front face may abut the elastic member such that the pushing member is clamped in between the first mechanical stop and the second mechanical stop via the elastic element. Preferably, the first front face of the pushing member may be a face of the first stepped portion or the first annular groove for receiving the elastic member of the pushing member.

Furthermore, the piston assembly may be configured to actuate the locking member via the first mechanical stop and the elastic member. Additionally or alternatively, the piston assembly may be movable along a linear actuation axis arranged in parallel to the rotation axis.

The first mechanical stop and the second mechanical stop may be disposed on a side of the piston assembly facing the rotation axis. The first and/or second mechanical stop may be formed as a circlip or a protruding lip of the piston assembly.

The elastic member may be disposed or at least partially disposed on a side of the piston assembly facing the rotation axis. By disposing the elastic member on a side of the piston assembly facing the rotation axis, a compact arrangement can be achieved. Furthermore, the elastic member is protected by the piston assembly from external influences such as impacts, shocks and bumps. Also, a further side of the piston assembly facing away from the rotation axis can be used for the hydraulic chamber without constraints caused by the elastic member.

The locking member may be configured as a locking sleeve. A locking sleeve allows to transfer force from the piston assembly and/or the elastic member equally to engagement members for locking the side gear to the differential planetary carrier.

The locking differential may comprise one or more engagement members, preferably in the form of one or more balls, wherein the locking sleeve may be configured to rotationally lock the side gear to the differential planetary carrier by forcing the engagement members into engagement with the side gear and with the differential planetary carrier. The differential planetary carrier may comprise a differential groove or a differential cage for receiving the engagement member.

The piston assembly may comprise an annular or cylindrical body portion symmetrically arranged with respect to the rotation axis.

Furthermore, a biasing member such as a return spring may be disposed in between at least a portion of the locking member and at least a portion of the differential planetary carrier. The return spring may be envisaged to bias the locking member to unlock the side gear from the differential planetary carrier or to allow the side gear to be unlocked from the differential planetary carrier. The return spring may be a compression spring such as a coil spring or a helical spring. The return spring may be made of spring steel.

Optionally, the elastic member may comprise a compression spring such as a coil spring or a helical spring. The elastic element may be made of spring steel. The two ends of the compression spring may be coupled to the portion of the piston assembly and the portion to the locking member.

Various objects and advantages of the present document will become apparent to those skilled in the art from the following detailed description of an embodiment of the presently proposed locking differential when read in light of the accompanying figures in which:

### DESCRIPTION OF THE FIGURES

FIG. 1 schematically shows a sectional view of a locking differential in an unlocked state in which a side gears are configured to turn relative to a differential planetary carrier;

FIG. 2 schematically shows a sectional view of the locking differential of FIG. 1 in a locked state in which the side gears are rotationally locked to the differential planetary carrier;

FIG. 3 schematically shows a sectional view of the locking differential of FIG. 1 in the unlocked state after a failed locking attempt;

FIG. 4a schematically shows a perspective view of a piston assembly, an elastic member and a pushing member of the locking differential of FIGS. 1 to 3; and

FIG. 4b schematically shows a sectional view of the piston assembly, the elastic member and the pushing member of FIG. 4a.

### DETAILED DESCRIPTION

In the following, recurring and similar features depicted in different figures are provided with the same reference numerals. The figures are drawn to scale. However, the features shown in the figures are not to be construed as being limited to the drawn scale. Absolute and/or relative sizes or dimensions of the features shown in the figures may differ from the sizes or dimensions illustrated herein.

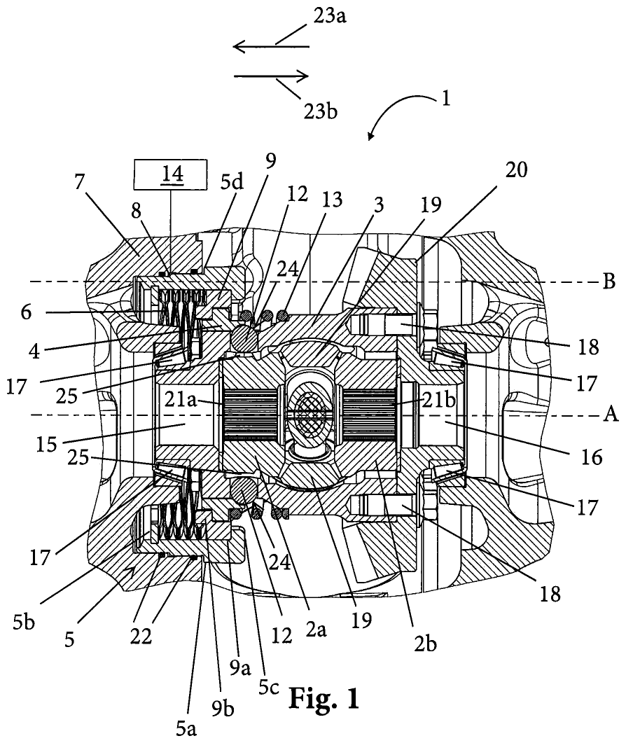

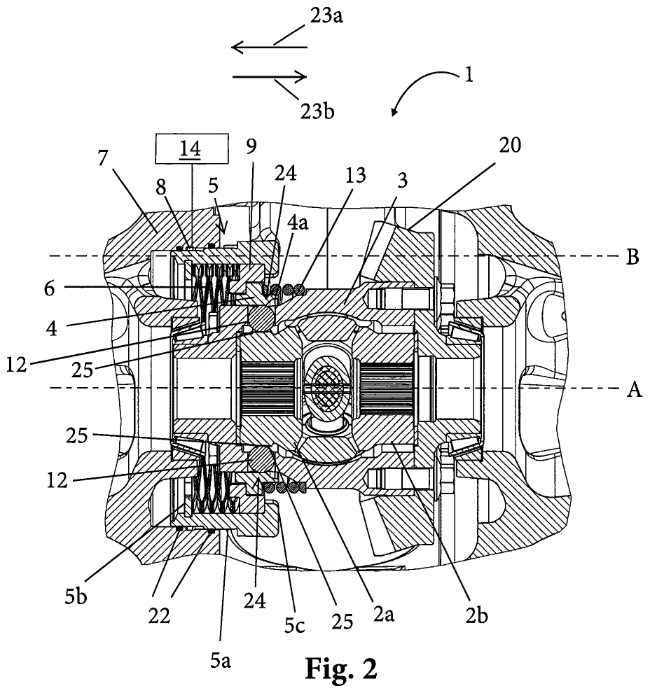

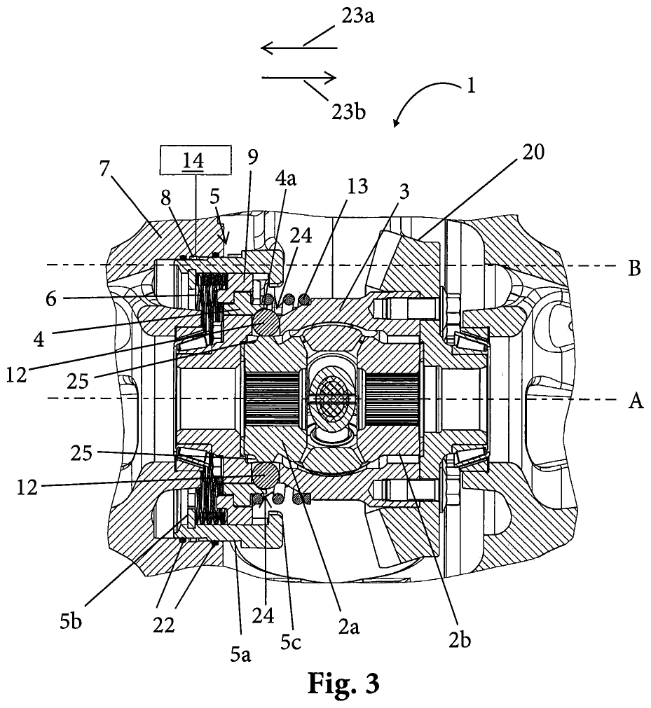

FIGS. 1 to 3 show a sectional view of an embodiment of a locking differential 1 for a vehicle of the presently proposed type. FIG. 1 shows the locking differential 1 in an unlocked state. FIG. 2 shows the locking differential 1 in a locked state. And FIG. 3 depicts the locking differential 1 after an unsuccessful attempt to shift the locking differential 1 from the unlocked state of FIG. 1 to the locked state of FIG. 2. As compared to locking differentials known from the prior art, the locking differential 1 is less susceptible to wear and damage that may be caused when a locking process fails. Furthermore, the locking differential 1 is well suited for being activated even when the vehicle is moving or when there is a difference in rotational speed between the right and left wheel of the vehicle.

The locking differential 1 shown in FIGS. 1 to 3 is disposed in a vehicle (not shown) and comprises a differential planetary carrier or differential housing 3. The differential planetary carrier 3 is configured to be driven by a ring gear 20. Here, the differential planetary carrier 3 and the ring gear 20 are fixedly connected via connecting members such as bolts 18. The differential planetary carrier 3 is configured to rotate relative to a stationary portion of the vehicle, for example relative to an axle housing portion 7, with respect to a rotation axis A. The differential planetary carrier 3 is rotationally mounted on the axle housing portion 7 via a set of bearings 17. The bearings 17 may be configured as tapered roller bearings, for example. Planetary gears or spider gears 19 are rotatably mounted on the differential planetary carrier 3. The differential planetary carrier 3 and the spider gears 19 rotatably mounted therein are configured to rotate in unison with respect to the rotation axis A. Additionally, the spider gears 19 may rotate relative to the differential planetary carrier 3 with respect to rotation axes which are disposed perpendicular to the rotation axis A.

The locking differential 1 further comprises side gears 2a, 2b each of which is configured to be connected to or engaged with an axle half shaft (not shown) for driving a vehicle wheel. For example, the side gears 2a, 2b may be engaged with the axle shafts via splined connections 21a, 21b. The side gears 2a, 2b are configured to rotate with respect to the rotation axis A. The differential planetary carrier 3 is configured to drive the side gears 2a, 2b via the spider gears 19. As the spider gears 19 may rotate with respect to the differential planetary carrier 3, the side gears 2a, 2b are configured to turn in different directions relative to the differential planetary carrier 3. Or in other words, as the differential planetary carrier 3 drives the side gears 2a, 2b via the spider gears 19, the side gears 2a, 2b may turn at different speeds relative to a stationary portion of a vehicle such as the axle housing portion 7. For instance, the side gears 2a, 2b driving the vehicle wheels may turn at different speeds when the vehicle drives around a curve.

However, in certain driving situations allowing the side gears 2a, 2b to turn in different directions relative to the differential planetary carrier 3 or, equivalently, to turn at different speeds relative to the axle housing portion 7 may be detrimental to vehicle controllability or driving comfort. For example, when one of the wheels driven by the side gears 2a, 2b loses ground grip or lifts off the ground, the fact that the side gears 2a, 2b may turn at different speeds relative to the axle housing portion 7 may cause this wheel and the side gear connected to it to overspeed. In such a situation, overspeeding of one of the side gears 2a, 2b may be prevented by rotationally locking the side gears 2a, 2b to the differential planetary carrier 3.

To this end, the locking differential 1 comprises engagement members 12. The engagement members 12 are configured to selectively rotationally lock the first side gear 2a to the differential planetary carrier 3. When the first side gear 2a is rotationally locked to the differential planetary carrier 3, the second side gear 2b, too, is rotationally locked to the differential planetary carrier 3 via the spider gears 19. When the side gears 2a, 2b are rotationally locked to the differential planetary carrier 3, the differential planetary carrier 3 and the side gears 2a, 2b turn at the same speed with respect to the rotation axis A, thereby preventing a potential overspeeding of one of the side gears 2a, 2a.

In the embodiment depicted in FIGS. 1 to 3, the engagement members 12 are configured as spherical members or balls which may be made of a metal such as steel, for example. However, it is understood that in alternative embodiments of the locking differential 1 not depicted here the engagement members 12 may have different forms or shapes and/or may be made of or may comprise different materials. Each of the engagement members 12 is disposed in a recess 24 formed in the differential planetary carrier 3. These recesses 24 are formed such that they restrict movement of the engagement members 12 relative to the differential planetary carrier 3 in a circumferential direction with respect to the rotation axis A and along the rotation axis A. On the other hand, the recesses 24 allow limited movement of the engagement members 12 relative to the differential planetary carrier 3 in a radial direction perpendicular to the axis of rotation A. The first side gear 2a includes structures 25 formed on an outer surface of the first side gear 2a, wherein the outer surface of the first side gear 2a faces away from the rotation axis A. The structures 25 are configured to receive or to at least partially receive the engagement members 12. The structures 25 are furthermore configured such that when the engagement members 12 are received or at least partially received within the structures 25, the structures 25 block or restrict movement of the engagement members 12 in a circumferential direction with respect to the rotation axis A. Thus, the first side gear 2a may be rotationally locked to the differential planetary carrier 3 by forcing the engagement members 12 into the structures 25 formed on the outer surface of the first side gear 2a.

To this end, the locking differential 1 further comprises a locking member 4. The locking member 4 is configured to force the engagement members 12 into the structures 25 on the outer side of the first side gear 2a rotationally lock the first side gear 2a to the differential planetary carrier 3.

In the embodiment depicted in the Figures the locking member 4 is configured as an annular or at least partially annular member or sleeve enclosing or extending around the rotation axis A. Here, the locking member 4 is disposed or mounted on an outer surface of the differential planetary carrier 3, wherein the outer surface of the differential planetary carrier 3 faces away from the rotation axis A. The locking member 4 may be made of a metal such as steel. However, it is understood that in alternative embodiments not depicted here the locking member 4 may have other designs or shapes and/or may be made of different materials. The locking member 4 is configured to move relative to the stationary axle housing portion 7, relative to the differential planetary carrier 3 and relative to the first side gear 2a along an actuation direction or actuation axis B. Here, the actuation axis B is arranged in parallel to the rotation axis A. However, it is understood that in alternative embodiments the actuation axis B and the rotation axis A may not be arranged in parallel. The locking member 4 is configured to slide on or over the outer surface of the differential planetary carrier 3. The locking member 4 is further configured to move or slide over the recesses 24 formed in the differential planetary carrier 3 to close or cap the recesses 24.

The locking differential 1 further comprises a piston assembly 5 and an elastic member 6. The piston assembly 5 is configured to actuate or to move or to push the locking member 4 via the elastic member 6 in order to rotationally lock the first side gear 2a to the differential planetary carrier 3. The elastic member 6 comprises or is configured as a compressible or at least partially compressible member such as a compression spring. In other words, the elastic member 6 is biased toward a non-compressed state and a force is required in order to compress or to at least partially compress the elastic member. The elastic member 6 may comprise or may be made of metal such as steel. However, it is understood that the elastic member 6 may comprise or may be made of other elastic materials.

The locking differential 1 depicted in the Figures further includes a pushing member 9 for conveying an actuation force between the piston assembly 5 and the locking member 4, in particular between the elastic member 6 and the locking member 4. The pushing member 9 has an annular or at least partially annular body portion 9a and a plurality of protrusions 9b protruding radially inward from the body portion 9a. In one or more sectional planes extending in parallel to the actuation axis B the body portion 9a and the protrusions 9b protruding from the body portion 9a form a step-like profile. The pushing member 9 is usually made of a non-compressible material. For example, the pushing member 9 may be made of or may comprise a metal such as steel. However, it is understood that the pushing member 9 may comprise or may be made of other non-compressible materials. The locking member 4 is disposed radially on an inner side of the pushing member 9, wherein the inner side of the pushing member 9 faces the rotation axis A. The locking member 4 is received or at least partially received within the pushing member 9. More specifically, the locking member 4 is received within the step-like profile formed by the body portion 9a and the protrusions 9b of the pushing member 9.

The locking differential 1 further includes a biasing member, in particular a return spring 13, for biasing the locking member 4 towards a position in which the locking member 4 allows the first side gear 2a and the differential planetary carrier 3 to disengage in order to unlock the first side gear 2a from the differential planetary carrier 3. The return spring 13 is supported on the differential planetary carrier 3 and is disposed in between at least a portion of the differential planetary carrier 3 and at least a portion of the locking member 4 along the actuation axis B.

The piston assembly 5 includes a body portion 5a, a first mechanical stop 5b and a second mechanical stop 5c. In the embodiment depicted in the Figures the body portion 5a and the second mechanical stop 5c are formed in one piece whereas the first mechanical stop 5b is configured as a separate member which is mounted on or fixedly mounted on the body portion 5a. For example, the first mechanical stop 5b may be a circlip disposed or received in a groove formed in the body portion 5a. However, it is understood that in alternative embodiments not depicted here either one or both of the mechanical stops 5b, 5c may be formed in one piece with the body portion 5a, or either one or both of the mechanical stops 5b, 5c may be formed as separate members mounted on or fixedly mounted on the body portion 5a.

In the embodiment depicted in the Figures, the body portion 5a has an annular or at least partially annular shape and encloses or surrounds the rotation axis A. Here, the piston assembly 5 is disposed or at least partially disposed radially in between the differential planetary carrier 3 and the axle housing portion 7. The piston assembly 5 is configured to move or to be moved relative to the axle housing portion 7 and relative to the differential planetary carrier 3. Here, the piston assembly 5 is configured to move or to be moved along the actuation axis B, i. e. in parallel to the rotation axis A. It is understood that in alternative embodiments not depicted here the piston assembly 5 may be configured to move or to be moved along directions other than the rotation axis A, or even along a curved path. For example, it is conceivable that in alternative embodiments the piston assembly 5 includes a rotatable lever portion that may rotate or that may be rotated along a curved path.

The mechanical stops 5b, 5c are disposed on a side of the body portion 5a facing the rotation axis A. More specifically, the mechanical stops 5b, 5c protrude from the body portion 5a toward the rotation axis A along the radial direction. The mechanical stops 5b, 5c are disposed at a distance from one another, in particular along the actuation axis B. In the embodiment of the locking differential 1 depicted here, both the elastic member 6 and the pushing member 9 are disposed or at least partially disposed on a side of the piston assembly 5 facing the axis of rotation A. The elastic member 6 and the pushing member 9 are received on an inner side of the piston assembly 5, wherein the inner side of the piston assembly 5 faces the axis of rotation A. Or in other words, both the elastic member 6 and the pushing member 9 are disposed or at least partially disposed radially in between the piston assembly 5 and the differential planetary carrier 3.

Along the actuation axis B, both the elastic member 6 and the pushing member 9 are disposed in between the mechanical stops 5b, 5c such that the mechanical stops 5b, 5c limit movement of the elastic member 6 and of the pushing member 9 relative to the piston assembly 5 along the actuation axis B. Along the actuation axis B the elastic member 6 is disposed or at least partially disposed in between the first mechanical stop 5b and the pushing member 9, and along the actuation axis B the pushing member 9 is disposed or at least partially disposed in between the elastic member 6 and the second mechanical stop 5c. The piston assembly 5 is configured to move or push the pushing member in a locking direction 23b along the actuation axis B via the first mechanical stop 5b and the elastic member 6. And the piston assembly 5 is configured to move or push the elastic member 6 in an unlocking direction 23a along the actuation axis B via the second mechanical stop 5c and the pushing member 9. Here, the locking direction 23b points from the first side gear 2a toward the second side gear 2b along the actuation axis B or along the rotation axis A. Conversely, the unlocking direction 23a points from the second side gear 2b toward the first side gear 2a along the actuation axis B or along the rotation axis A. Along the actuation axis B the locking member 4 is disposed on a side of the pushing member 9 facing away from the elastic member 6. Thus, the pushing member 9 is configured to move or push the locking member 4 in the locking direction 23b, in particular by means of the protrusions 9b. Conversely, the locking member 4 is configured to move or push the pushing member 9 in the unlocking direction 23a.

In the embodiment depicted here, the piston assembly 5 is configured to be actuated hydraulically. To that end, the locking differential 1 includes a hydraulic chamber 8 formed in between the piston assembly 5 and a portion of the axle housing portion 7. More specifically, the hydraulic chamber 8 is formed radially in between an outer surface of the piston body portion 5a and an inner surface of the axle housing portion 7, wherein the inner surface of the axle housing portion 7 faces the rotation axis A and the outer surface of the piston body portion 5a faces away from the rotation axis A. Along the actuation axis B, the hydraulic chamber is delimited or sealed by a pair of seals 22. For example, each of the seals 22 may include a rubber sealing ring radially disposed in between the piston assembly 5 and the axle housing portion 7. Typically, the hydraulic chamber 8 is in fluid communication with a reservoir 14 configured to hold a liquid such as oil. The piston assembly 5 may then be moved relative to the axle housing portion 7 and relative to the differential planetary carrier 3 by selectively displacing liquid between the reservoir 14 and the hydraulic chamber 8. For example, the locking differential 1 may include a flow generating device such as a hydraulic pump for displacing the liquid. Specifically, the piston assembly 5 may be actuated or moved to rotationally lock the first side gear 2a to the differential planetary carrier 3 by displacing liquid from the reservoir 14 to the hydraulic chamber 8, and the piston assembly 5 may be moved to allow the first side gear 2a and the differential planetary carrier to unlock or to disengage by displacing liquid from the hydraulic chamber to the reservoir 14 or by allowing liquid to be displaced from the hydraulic chamber 8 to the reservoir 14.

It is understood that in alternative embodiments of the locking differential 1 not explicitly depicted here the piston assembly 5 may be configured to be actuated by other means. For example, the piston assembly 5 may be configured to be moved by electromagnetic forces.

In the following, the processes of locking and of unlocking the locking differential 1 and the particular advantages of the locking differential 1 over known locking differentials are described.

In FIG. 1, the locking differential 1 is in an unlocked state. The return spring 13 holds the locking member 4 in a position in which the locking member 4 clears the recesses 24 and allows the engagement members 12 to move out of the structures 25 of the differential planetary carrier 3 and to at least partially protrude out of the recesses 24, thereby allowing the first side gear 2a to disengage from the differential planetary carrier 3. Via the locking member 4, the pushing member 9, the elastic member 6 and the first mechanical stop 5b of the piston assembly 5, the return spring 13 biases the piston assembly 5 in the unlocking direction 23a along the actuation axis B, here away from the second side gear 2b and toward the axle housing portion 7. A shoulder portion 5d of the piston assembly 5 abuts a portion of the axle housing portion 7 so that the axle housing portion 7 limits movement of the piston assembly 5 in the unlocking direction 23a. The volume of the hydraulic chamber 8 formed in between the piston assembly 5 and the axle housing portion 7 takes on its minimum value. The elastic member 6 disposed in between the first mechanical stop 5b and the pushing member 9 along the actuation axis B is partially compressed, thereby biasing the pushing member 9 against the second mechanical stop 5c.

By contrast, in FIG. 2 the locking differential 1 is in a locked state. In the locked state depicted in FIG. 2, the locking member 4 closes or caps the recesses 24 formed in the differential planetary carrier 3, thereby forcing the engagement members 12 into the structures 25 on the outer side of the first side gear 2a and into engagement with the first side gear 2a so that the first side gear 2a is rotationally locked to the differential planetary carrier 3. The second side gear 2b, too, is rotationally locked to the differential planetary carrier 3 via the spider gears 19. In the locked state shown in FIG. 2, the side gears 2a, 2b are forced to turn in unison with the differential planetary carrier 3 with respect to the rotation axis A.

In order to place or shift the locking differential 1 from the unlocked state shown in FIG. 1 to the locked state shown in FIG. 2, the flow generating device pumps liquid from the reservoir 14 into the hydraulic chamber 8, thereby pushing the piston assembly 5 in the locking direction 23b along the actuation axis B, here toward the second side gear 2b. Via the first mechanical stop 5b, the elastic member 6 and the pushing member 9, the piston assembly 5 pushes the locking member 4 in the locking direction 23b along the actuation axis B, thereby sliding the locking member 4 over the recesses 24 and compressing or at least partially compressing the return spring 13. Importantly, for the piston assembly 5 to be able to move or push the locking member 4 in the locking direction 23b and to compress or at least partially compress the return spring 13 via the elastic member 6 when the elastic member 6 is only partially compressed, a stiffness of the elastic member 6 in the only partially compressed state of the elastic member 6 has to be greater than a stiffness of the return spring in an uncompressed or partially compressed state of the return spring 13.

As the piston assembly 5 pushes or slides the locking member 4 in the locking direction 23b along the actuation axis B and over the recesses 24, a tapered end portion 4a of the locking member 4 pointing in the locking direction 23b forces the engagement members 12 into or further into the recesses 24 and into the structures 25 formed on the outer side of the first side gear 2a.

FIG. 3 shows a sectional view of the locking differential 1 in an unlocked state after a failed attempt to shift the locking differential 1 from the unlocked state shown in FIG. 1 to the locked state shown in FIG. 2. For example, the process of shifting the locking differential 1 to the locked state may fail if the piston assembly 5 is pushed in the locking direction 23b at a time when a difference in rotational speed between the first side gear 2a and the differential planetary carrier 3 is higher than a threshold rotational speed difference. In this case, the engagement members 12 may be hindered from being received in the structures 25 on the outer side of the first side gear 2a and from engaging with the first side gear 2a so that the engagement members 12 block movement of the locking member 4 in the locking direction 23b past the engagement members 12 and over the recesses 24. However, even as the engagement members 12 protruding out of the recesses 24 block further movement of the locking member 4 in the locking direction 23b, the piston assembly 5 may continue to move in the locking direction 23b by compressing or by at least partially compressing the elastic member 6. For example, the elastic member 6 may be configured such that compression or partial compression of the elastic member 6 during a failed locking attempt may reduce an extension of the elastic member 6 by at least 20 percent, by at least 30 percent, by at least 40 percent, or by at least 50 percent. In the embodiment of the locking differential 1 depicted in FIG. 3, further movement of the piston assembly 5 compresses or partially compresses the elastic member 6 in between the first mechanical stop 5b and the pushing member 9. The piston assembly 5 and the elastic member 6 may be arranged and configured such that during a failed locking attempt as described here the piston assembly 5 may continue a complete stroke.

In this manner, when movement or further movement of the locking member 4 in the locking direction 23b is blocked, a force exerted on the engagement members 12 via the locking member 4 and forcing the engagement members 12 toward engagement with the first side gear 2a is limited. This may significantly reduce wear of mechanical parts such as the locking member 4, the engagement members 12 and the structures 25 of the first side gear 2a. In the embodiment depicted in the Figures in which the piston assembly 5 is configured to be actuated hydraulically, the fact that the piston assembly may continue to move in the locking direction 23b when movement or further movement of the locking member 4 in the locking direction 23b is blocked additionally reduces a maximum pressure in the hydraulic chamber 8, thereby reducing wear of the seals 22 and preventing or reducing leakage of liquid out of the hydraulic chamber 8. A person of ordinary skill readily understands that as compared to known locking differentials the locking differential 1 has an improved functionality, provides enhanced operability and has a prolonged service life.

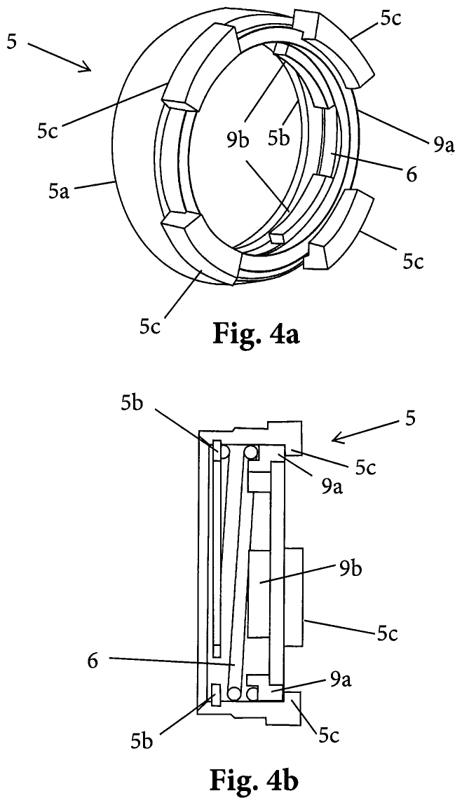

FIGS. 4a and 4b show, respectively, a perspective view and a sectional view of the piston assembly 5, the elastic member 6 and the pushing member 9 previously described with reference to FIGS. 1 to 3. FIGS. 4a and 4b illustrate that the protrusions 9b of the pushing member 9 are spaced apart in the circumferential direction, and that, similarly, the second mechanical stop 5c of the piston assembly 5 may comprise a plurality of mechanical stops spaced apart in the circumferential direction.

1-15. (canceled)

16. A locking differential, comprising:
a side gear,
a differential planetary carrier for driving the side gear,
a locking member for selectively rotationally locking the side gear to the differential planetary carrier,
a piston assembly for actuating the locking member, and
an elastic member,
wherein in order to rotationally lock the side gear to the differential planetary carrier the piston assembly is configured to actuate the locking member via the elastic member.

17. The locking differential of claim 16, wherein the piston assembly, the elastic member and the locking member are configured such that when a locking movement of the locking member is blocked before the locking member rotationally locks the side gear to the differential planetary carrier, the piston assembly is configured to move relative to the locking member by compressing or by partially compressing the elastic member in between the piston assembly and the locking member.

18. The locking differential of claim 16, further comprising an axle housing portion and a hydraulic chamber formed in between the axle housing portion and the piston assembly, wherein the hydraulic chamber is configured to be filled with a liquid in order to move the piston assembly to rotationally lock the side gear to the differential planetary carrier.

19. The locking differential of claim 16, further comprising a pushing member disposed in between at least a portion of the elastic member and at least a portion of the locking member such that in order to rotationally lock the side gear to the differential planetary carrier the piston assembly is configured to actuate the locking member via the elastic member and the pushing member.

20. The locking differential of claim 16, wherein the piston assembly comprises a first mechanical stop and a second mechanical stop, wherein the elastic member or at least a portion of the elastic member is disposed in between the first mechanical stop and the second mechanical stop such that the first mechanical stop and the second mechanical stop limit movement of the elastic member relative to the piston assembly.

21. The locking differential of claim 20, wherein at least a portion of the pushing member is disposed in between the elastic member and the second mechanical stop such that the second mechanical stop limits movement of the pushing member relative to the piston assembly.

22. The locking differential of claim 21, wherein the piston assembly is configured to actuate the locking member via the first mechanical stop and the elastic member.

23. The locking differential of claim 20, wherein the differential planetary carrier and the side gear define a rotation axis and wherein the piston assembly is movable along a linear actuation axis arranged in parallel to the rotation axis.

24. The locking differential of claim 23, wherein the first mechanical stop and the second mechanical stop are disposed on a side of the piston assembly facing the rotation axis.

25. The locking differential of claim 24, wherein the elastic member is disposed or at least partially disposed on a side of the piston assembly facing the rotation axis.

26. The locking differential of claim 16, wherein the locking member is configured as a locking sleeve.

27. The locking differential of claim 26, further comprising one or more engagement members, in the form of one or more balls, wherein the locking sleeve is configured to rotationally lock the side gear to the differential planetary carrier by forcing the engagement members into engagement with the side gear and with the differential planetary carrier.

28. The locking differential of claim 16, wherein the differential planetary carrier and the side gear define a rotation axis and wherein the piston assembly comprises an annular or cylindrical body portion symmetrically arranged with respect to the rotation axis.

29. The locking differential of claim 16, further comprising a return spring disposed in between at least a portion of the locking member and at least a portion of the differential planetary carrier, the return spring biasing the locking member to unlock the side gear from the differential planetary carrier or to allow the side gear to be unlocked from the differential planetary carrier.

30. The locking differential of claim 16, wherein the elastic member comprises a compression spring such as a coil spring or a helical spring.
